(19) United States
(12) Patent Application Publication
(10) Pub. No.: US 2005/0126720 A1
(43) Pub. Date: Jun. 16, 2005

(54) Chain driven articulated door

(75) Inventor: Andrew Rekret, North York (CA)

Correspondence Address: DENNISON ASSOCIATES, SUITE 301, 133 RICHMOND ST., TORONTO, ON, M5H 2L7, CA

(73) Assignee: MASTERCORE TECHNOLOGIES LTD.

(21) Appl. No.: 10/733,297

(22) Filed: Dec. 12, 2003

(51) Int. Cl. E05D 15/16

(52) U.S. Cl. 160/201

(57) ABSTRACT

An articulated door is formed from a plurality of panels hingedly connected to one another. Each of the panels has an end fitting. The end fittings of the panels are pivotally linked with one another to form a chain to one side of the articulated door. A rotatable tooth gear engages the chain for opening and closing the articulated door.

### FIELD OF THE INVENTION

The present invention relates to an articulated or rolling door and a drive system for opening and closing the door.

### BACKGROUND OF THE INVENTION

Articulated doors are formed from a plurality of panels hingedly connected to one another. These types of doors are becoming more and more popular for many different uses. They are for example used to cover large openings to garages and warehouse spacing etc. They are further used as rear truck doors on large truck trailers.

In the past, articulated doors were typically made from wood or lightweight steel materials. More recently there have been developments with respect to plastic panels which have become particularly suitable for use in rolling door applications.

A conventional rolling door is provided with cables to opposite sides of the door. These cables are used to raise and lower the door. In many garage type setups an automatic control in the form of a bar secured to the roof of the garage and extending to the upper end of the door is used to provide automatic opening and closing of the door. These garage door controllers are further able to hold or lock the garage door in its closed position.

It is not known in the trucking industry to use the conventional automatic door opener for a truck trailer door. This is because of the overhead space limitations of the trailer. A conventional roll up truck trailer door is therefore manually operated and necessitates a door lock for securing the door in its closed position.

### SUMMARY OF THE PRESENT INVENTION

The present invention provides a door system based on a chain drive for opening and closing an articulated door. The system of the present invention is one which has numerous different applications including truck trailer applications. In these particular applications the truck trailer door can be opened and closed using a power drive without having space limitation concerns.

In particular, a door assembly of the present invention comprises an articulated door formed from a plurality of preferably plastic panels hingedly connected to one another. Each of the panels has an end fitting. The end fitting of the panels are pivotally linked with one another to form a chain to the side of the articulated door.

The assembly further includes a rotatable toothed gear which engages the chain formed by the end fittings for opening and closing the articulated. The toothed gear may be a power driven gear.

### BRIEF DESCRIPTION OF THE DRAWINGS

The above as well as other advantages and features of the present invention will be described in greater detail according to the preferred embodiments of the present invention in which;

FIG. 1 is a perspective view of the rear of a truck trailer provided with an articulated door according to a preferred embodiment of the present invention;

FIG. 2 is a perspective view of the ends of two connected panels from the door of FIG. 1;

FIG. 3 is an exploded perspective view of one of the panel ends of FIG. 2 fitted with a chain forming end fitting according to a preferred embodiment of the present invention;

FIG. 4 is an exploded perspective view of the drive system for engaging the panel end fitting of FIG. 3; and

FIG. 5 is a side view showing operation of the drive system of FIG. 4.

### DETAILED DESCRIPTION ACCORDING TO THE PREFERRED EMBODIMENTS OF THE PRESENT INVENTION IN WHICH

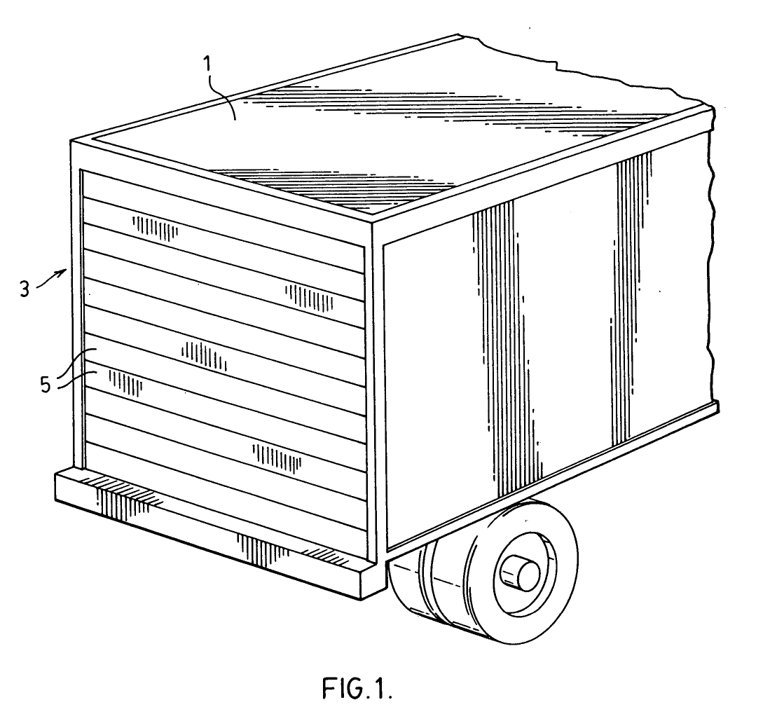

FIG. 1 shows a truck trailer 1 provided with a roll up articulated door generally indicated at 3. This door is formed from a plurality of door panels 5.

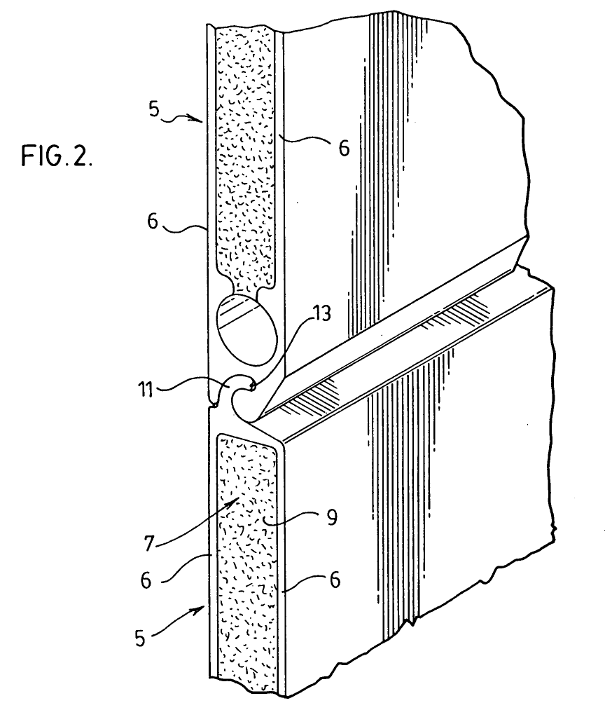

A pair of these panels secured to one another are shown in FIG. 2 of the drawings. As will be seen according to this preferred embodiment each of the panels comprises a resin wall 6 surrounding an interior region of the panel. When the panels are initially formed this interior region is hollow and then preferably filled with a foam material 9.

The panels are all identical in construction with one another. Each panel includes a curved tail 11 at one end of the panel and a correspondingly shaped slot 13 at the other end of the panel. The tail of one panel fits into the slot of an adjacent panel to form a hinged joint between panels.

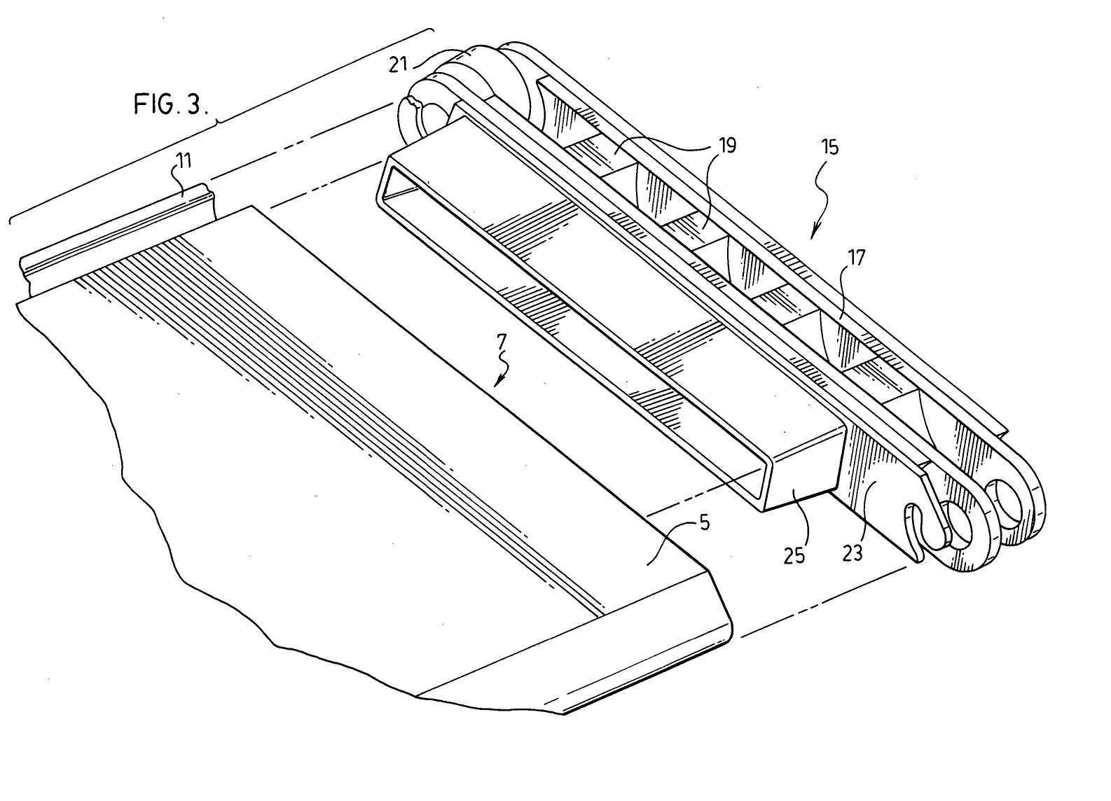

FIG. 3 of the drawings shows an end fitting generally indicated at 15 which fits into the open end 7 of each of the panels 5. Preferably, there is an end fitting at each end of each panel.

End fitting 15 comprises a link part 17 provided with internal lugs 19 and spaces between the lugs. A roller 21 is rotatably trapped to one end of the link as shown in FIG. 3.

Provided on the outside surface of link 17 is a cover plate 23 with a plug part 25 projecting from plate 23.

Like panel 5 end fitting 15 preferably has a resin base construction. The end fitting may be injection molded from a relatively hard durable plastic material such as nylon or the like. The panel on the other hand is preferably made in an extrusion or even a pultrusion process. Foam material 9 may be introduced to the interior of panel 5 as the panel is being formed. The pultrusion process lends itself particularly well to formation of the panel while simultaneously injecting the foam into the interior of the panel.

End fitting 15 is mounted to panel 5 by pushing plug part 25 of the end fitting into the open end 7 of the panel. The plug portion will then embed itself into the foam material to secure the fitting with the panel end. Adhesives may also be used to assist in securing the panel and the fittings to one another.

As an alternative method of securing the fitting with the panel, the plug part 25 of the fitting can be pushed into the open end of the panel before foaming. The injected foam will then fill the hollow interior of plug part 25. The foam hardens within the plug part to secure the end fitting with the panel.

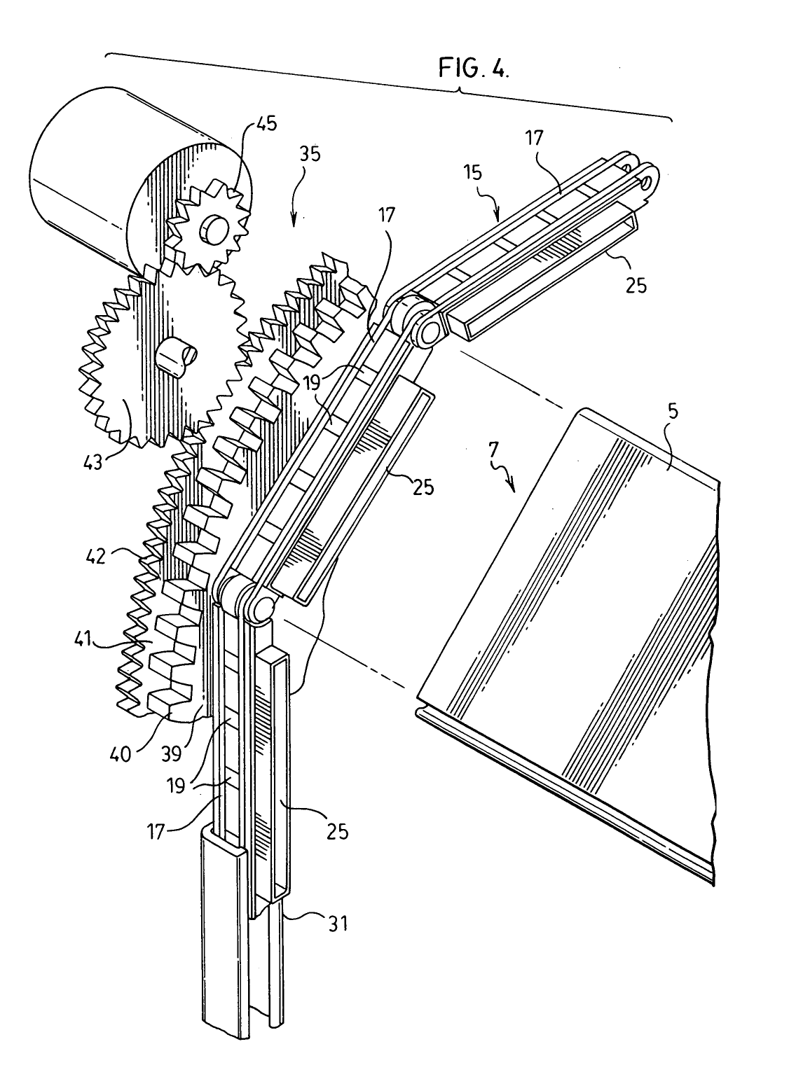

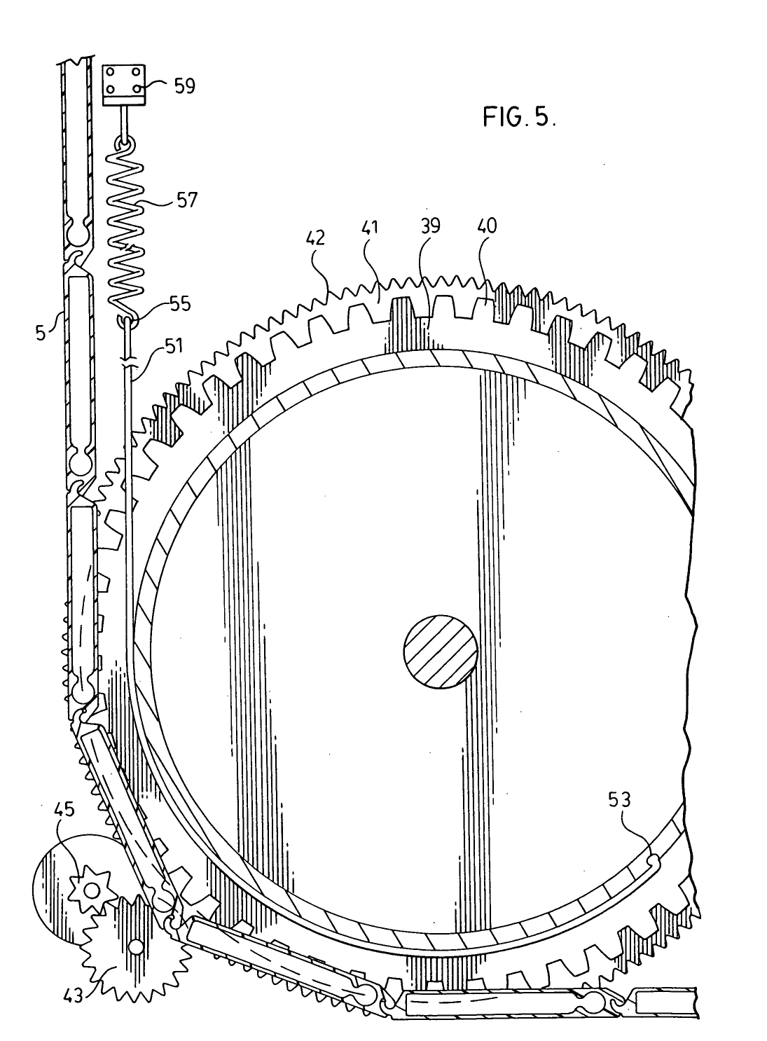

FIGS. 4 and 5 of the drawings shows how a chain is formed by connecting end-to-end end fittings between the side by side connected panels of door 3. These figures also show how the chain engages with and is driven by a power drive system for opening and closing articulated door 3.

In FIG. 4 it will seen that a plurality of end fittings 15 are pivotally connected at the rollers 21 to one another. The rollers align with the pivotal connections between the panels. The links 17 of these end fittings form a length of chain. Each of the end fittings is plug fitted into an aligned one of the panels 5 to secure the chain along the edge of the door.

A drive system generally indicated at 35 operates in conjunction with the chain formed by the end fittings to raise and lower door 3. This drive system comprises a rotary gear 39 having teeth 40. Teeth 40 and more particularly the gaps between teeth 40 engage the lugs 19 of the chain links 17.

Rotary gear 39 is attached to a second rotary gear 41 having teeth 42. The teeth 42 of gear 41 engage with correspondingly shaped teeth of a transfer gear 43. Transfer gear 43 is rotated by a power driven gear 45.

The chain formed by the panel end fittings is guided in its up and down travel by means of a track 31 mounted to the interior of the truck.

FIG. 5 of the drawings shows the drive system as including a cable 51 having its one end 53 attached to gear 39. The other end of cable 51 is attached at 55 to load biasing spring 57 secured at 59 to an inside surface of the truck body. The bias provided by spring 57 at the different up and down positions of the door is set to substantially offset weight of the door. As such the power required to drive system 35 is minimal e.g., simply enough to overcome inertia in starting the door to move from a stopped position.

As earlier noted the door assembly of the present invention will typically include a power drive system as described immediately above to both sides of the door for a balanced opening and closing of the door.

A further benefit provided by the power drive system is that when the main drive gear 45 is not in operation it is locked against rotation. This in turn locks up the rest of the assembly which eliminates the need for any type of an external lock on the door. As can be seen with respect in FIG. 1 door 3 does not include an external door lock.

Although various preferred embodiments of the present invention have been described in detail, it will be appreciated by those skilled in the art that variations may be made without departing from the spirit of the invention or the scope of the appended claims.

1. A door assembly comprising an articulated door formed from a plurality of panels hingedly secured to one another, each of said panels being fitted to at least one end thereof with a chain link part extending across the end of the panel, said assembly including a rotatable toothed gear which is rotated by a drive system of said assembly and which engages the chain link part at the end of each of the panels for opening and closing the articulated door.

2. A door assembly as claimed in claim 1 wherein each of said panels comprises a resin based outer shell filled with a rigid foam material and said chain link part comprises an end fitting of the panel fitted to the outer shell covering the rigid foam material.

3. A door assembly as claimed in claim 2 wherein said end fitting has a plug portion which fits into the shell of the panel, the chain link part being attached to from the plug portion.

4. A door assembly as claimed in claim 2 wherein said assembly includes a guide track and said end fitting includes a roller to each end of the chain link part, the rollers of the end fitting being located in and riding along the guide track.

5. A door assembly as claimed in claim 1 wherein said drive system comprises a second gear attached to a side of said toothed gear and a power operated drive gear which engages with said second gear to rotate said toothed gear.

6. A door assembly comprising an articulated door formed by a plurality of panels secured by hinge connections to one another, and a drive system for opening and closing said door, said drive system comprising a chain formed by a plurality of links, the links comprising end fittings of the panels and each link presenting a engaging part, the links of the chain being secured by pivot connections aligned with the hinge connections of the panels, said chain including rollers at each of the pivot connections of the chain, a guide track along which the rollers of the chain travel as the door is opened and closed and a drive system for opening and closing the door.

7. A door assembly as claimed in claim 6 wherein said drive system comprises a rotating toothed gear which engages the links of the chain, a second gear attached to one side of the rotating toothed gear and a power drive gear which turns said second gear to rotate said toothed gear.

8. A door assembly as claimed in claim 7 wherein the end fittings include plug portions which push into the ends of the panels.

9. A door assembly as claimed in claim 8 wherein each of the panels comprises an outer shell of resin based material, the shell being filled with a solid foam material which is covered by the plug portion of the end fitting.

10. A door assembly comprising an articulated door formed from a plurality of panels hingedly connected to one another, each of said panels having an end fitting, the end fittings of the panels being pivotally linked with one another to form a chain to one side of the articulated door, said assembly further including a rotatable toothed gear which engages the chain formed by the end fittings for opening and closing the articulated door.

11. A door assembly as claimed in claim 10 wherein said panels and said end fittings have a resin based construction, each of said end fittings comprising a chain link part and a plug part, the panels having open ends and the plug parts of the end fittings being pushed into the open ends of the panels.
